(19) United States
(12) Patent Application Publication
(10) Pub. No.: US 2014/0115241 A1
(43) Pub. Date: Apr. 24, 2014

(54) BUFFER MANAGEMENT APPARATUS AND METHOD

(71) Applicant: Qingsong Wei, Singapore (SG)

(72) Inventor: Qingsong Wei, Singapore (SG)

(21) Appl. No.: 14/122,673

(22) PCT Filed: May 24, 2012
(86) PCT No.: PCT/SG2012/000184

§ 371 Date: Nov. 26, 2013

(30) Foreign Application Priority Data
May 30, 2011 (SG) 201103945-0

(51) Int. Cl. G06F 12/02

(52) U.S. Cl. CPC G06F 12/0246
USPC 711/103

(57) ABSTRACT

A buffer management apparatus (101) for managing transfer of data between a host processor (102) and a flash-based memory (114) is disclosed. The apparatus (101) comprises a buffer (110) having a memory for caching the data to be transferred, the memory being logically partitioned as a page-based buffer partition configured with a plurality of first memory pages, and a block-based buffer partition configured with a plurality of memory blocks. Each memory block includes the same number of memory pages as an erasable block in the flash-based memory, and the host processor (102) is configured to access the page-based buffer partition or the block-based buffer partition based on type of data to be transferred. A related method and a buffer for flash-based memory are also disclosed.

### FIELD

The present invention relates to a buffer management apparatus and method.

### BACKGROUND

Flash memory is rapidly maturing into a promising technology as the next-generation of storage means due to a number of strong technical merits including having low access latency, low power consumption, higher resistance to shocks, and being light weight. As an emerging technology, flash memory thus has received strong interest from both the academia and commercial sectors. Flash memory is traditionally used in portable devices, but recently, a significant drop in their prices coupled with huge increase in available capacity sizes has allowed this technology to make huge strides into personal computer and server storage space in the form of Solid State Drives (SSDs).

However, SSDs typically suffer from the random writes issue when deployed in enterprise environments. Firstly, random writes are much slower than sequential writes, and existing performance optimisations for the SSDs, including striping and interleaving, are then not as effective for random writes simply because lesser sequential locality remains to be exploited. Secondly, NAND flash memory allows only a finite number of erases for a given physical memory block. Random writes intensive workload may thus result in the flash memory wearing out hundred times faster than sequential writes intensive workload. Finally, random writes result in higher overhead in terms of garbage collection than sequential writes. If incoming writes are randomly distributed over the logical block address space, all the physical memory blocks will eventually suffer from fragmentation, which has significant implications on garbage collection and overall performance. Therefore, preserving the sequentiality of write accesses being forwarded to the flash memory is critical to both the performance and operational lifetime of the SSDs.

On the other hand, background garbage collection and wear leveling inside the SSDs compete for internal resources with the foreground user accesses. If most foreground user accesses can obtain a hit in the buffer cache, the influences of each other on the other may be reduced significantly. Achieving a high cache hit ratio significantly reduces the direct accesses from/to the flash memory, which consequently helps in attaining low latency for foreground user accesses and conserve resources for background tasks. Therefore, both the cache hit ratio and sequentiality are two critical factors in determining the efficiency of buffer management schemes used for flash memory.

There are currently several major efforts being pursued in the area of buffer management for SSDs, which may broadly be classified as page-based or block-based buffer management schemes. Most of the schemes are based on the existence of locality in access patterns, specifically in terms of temporal locality or spatial locality. However, none of the schemes are able to achieve both high cache hit ratio and good sequentiality.

Page-based buffer management schemes adopt cache hit ratio improvement as the sole criterion to exploit the temporal locality of data accesses. A number of these page-based algorithms (e.g. LRU, CLOCK, WOW, 2Q, ARC or the like) have been proposed. All these algorithms are mainly directed at how to better utilise temporal locality to minimize the occurrence of page faults. However, direct application of such algorithms to SSDs is inappropriate because they do not consider the spatial locality characteristics of the accesses.

On the other hand, block-based buffer management schemes (e.g. FAB, BPLRU, LB-CLOCK or the like) exploit spatial locality to provide more sequential writes for the flash memory. Pages in the buffer are grouped based on their block associations. When a page in the buffer is accessed, all other pages in the same block are then moved to the head of an access list based on an assumption that all pages in this block possess the same recency. However due to the fact that hundreds of pages exist in an erasure block, this assumption may not be valid, especially for random dominant workloads. Since the block position in the buffer list is determined by partial page accesses, most pages in this block may not be accessed subsequently, which then pollutes the buffer space. To create free space in the buffer, all pages in the victim block are to be removed simultaneously. However, there exist certain pages in the victim block might later be accessed by a host system. As a result, this strategy tradeoffs spatial locality with temporal locality, which gives low buffer space utilisation and low cache hit ratio. Since the buffer size is critical to energy consumption and the costs of SSDs, it is therefore important to improve buffer space utilisation.

Workloads generated in an enterprise-level system are typically a mixture of random and sequential accesses, implying the existence of both temporal locality and spatial locality. Both the page-based and block-based buffer management schemes however fail to advantageously exploit both temporal and spatial localities simultaneously.

One object of the present invention is therefore to address at least one of the problems of the prior art and/or to provide a choice that is useful in the art.

### SUMMARY

According to a 1^{st} aspect of the invention, there is provided a buffer management apparatus for managing transfer of data between a host processor and a flash-based memory is disclosed. The apparatus comprises a buffer having a memory for caching the data to be transferred, the memory being logically partitioned as a page-based buffer partition configured with a plurality of first memory pages, and a block-based buffer partition configured with a plurality of memory blocks. Each memory block includes a same number of pages as an erasable block in the flash-based memory, and the host processor is configured to access the page-based buffer partition or the block-based buffer partition based on type of data to be transferred.

The proposed apparatus is advantageously configured to achieve a high cache hit ratio and good sequentiality by exploiting both the temporal and spatial localities among access patterns. Particularly, in the page-based buffer partition, buffer data is managed based on page granularity for improving buffer space utilisation, while in the block-based buffer partition, data are managed based on block granularity. Further, preference is granted for maintaining random access pages in the page-based buffer partition, while on the other hand, sequential access pages in the block-based buffer partition are configured to be replaced first.

Additionally, buffer data in the page-based buffer partition are dynamically migrated to the block-based buffer partition, if the number of pages in a block reaches or exceeds a threshold value, which is adaptively determined based on the workload type being managed. This efficiently improves the corresponding related performance, and influences the Input/Output requests received so that more sequential accesses are to be forwarded to the flash-based memory. Based on the described configuration, the apparatus thus achieves higher performance (in terms of having higher cache hit ratio, and better sequentiality), incurs less garbage collection overhead, enables more sequential writes forwarding to the flash-based memory, is workload adaptive, and more cost effective due to higher utilisation of the buffer space.

Preferably, the apparatus may further comprise a processor configured to replace data in the page-based buffer partition based on Least Recently Used (LRU) algorithm. In addition, each memory block of the block-based buffer partition may be associated with a popularity index which tracks the number of times the associated memory block is accessed. Moreover, the data to be transferred may include sequential access of multiple second memory pages of one of the memory blocks, and wherein the processor may be configured to increase the popularity index associated with the one of the memory blocks by one count.

More preferably, the data to be transferred may include random access of one of the second memory pages of the memory block, and wherein the processor may be configured to increase the popularity index associated with the memory block by one count. Furthermore, if the access is a write operation, the processor may be configured to check the block-based buffer partition for availability of a corresponding block of memory, and if available, to write to the corresponding block memory.

Yet further, after the write operation, the processor may preferably be configured to update the popularity index and to reorder the memory blocks in the block-based buffer partition. Additionally, if the corresponding block of memory is not available, the processor may be configured to write to beginning of the page-based buffer partition and update a block node with pages of the written data. Preferably, if the number of page in a block reaches a threshold, the processor may be configured to migrate all pages of the block to the block-based buffer partition.

Yet more preferably, the threshold may be a value between 1 and the total number of pages in one erasable block of the flash-based memory. Also, the processor may be configured to determine a ratio of size of the block-based buffer partition and size of the buffer, and to dynamically modify the threshold based on the ratio. Further, the processor may be configured to replace data in the memory blocks of the block-based buffer partition based on the popularity index. Specifically, the memory block having a lowest popularity index may be replaced first, whereas if a plurality of the memory blocks has a same popularity index, the memory block having more pages may be replaced first.

Preferably, if there are dirty pages in said block, both dirty pages and clean pages of said block may be sequentially flushed into the flash-based memory. In addition, if there are no dirty pages in said block, all the clean pages of said block may be discarded. Otherwise, if a said block region is empty, the least recently used page may be selected as a victim page from the page-based buffer partition, and pages belonging to the same block as the victim page may be replaced and flushed. Yet preferably, the flash-based memory may be NAND memory.

According to a 2^{nd} aspect of the invention, there is provided a buffer management method for managing transfer of data between a host processor and a flash-based memory. The method comprises logically partitioning a memory of a buffer for caching the data to be transferred as a page-based buffer partition and a block-based buffer partition, configuring the page-based buffer partition with a plurality of first memory pages, configuring the block-based buffer partition with a plurality of memory blocks with each memory block including a same number of pages as an erasable block in the flash-based memory, and accessing the page-based buffer partition or the block-based buffer partition based on type of data to be transferred.

Preferably, the method may further comprise dynamically migrating the data in the page-based buffer partition to the block-based buffer partition in dependence on a predetermined threshold value, which may be adaptively adjusted in accordance to a workload representative of the transfer of the data between the host processor and flash-based memory.

According to a 3^{rd} aspect of the invention, there is provided a buffer for flash-based memory, the buffer comprising memory for caching data, the memory being logically partitioned as a page-based buffer partition configured with a plurality of first memory pages, and a block-based buffer partition configured with a plurality of memory blocks, each memory block having a same number of pages as an erasable block in the flash-based memory, wherein whether the page-based buffer partition or the block-based buffer partition is accessed is based on type of data to be transferred.

Preferably, the flash-based memory may be NAND memory.

According to a 4^{th} aspect of the invention, there is provided a buffer management apparatus configured for managing transfer of data between a host processor and a flash-based memory using the buffer management method of the 2^{nd} aspect of the invention. The apparatus comprises a write buffer configured for buffer management based on block granularity, and a read cache configured for buffer management based on page granularity. The data subsequently stored in the write buffer and read cache are associated based on block association, and the data stored in the write buffer are to be subsequently replaced and flushed to the flash-based memory in cooperative dependence on the data stored in the read cache.

Preferably, the data stored in the write buffer and read cache may subsequently be replaced and flushed to the flash-based memory together, if the data stored in the write buffer and read cache belong to a same memory block. In addition, the write buffer and read cache may include non-volatile memory or volatile memory.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 is a schematic diagram of a system architecture of a solid-state device (SSD), according to a first embodiment of the invention;

FIG. 2 is an alternative representation of the system architecture of FIG. 1;

FIG. 3 is a block diagram of a NAND flash memory used in the SSD of FIG. 1;

FIG. 4 illustrates division of the data buffer of the SSD of FIG. 1 into a page region and a block region in accordance with a Hybrid Buffer Management (HBM) method, according to a second embodiment of the invention;

FIG. 5 is a flow diagram illustrating how the HBM of FIG. 4 manages read/write access requests;

FIG. 6 is a flow diagram of a replacement policy method incorporated into the method of FIG. 4;

FIG. 7 illustrates a threshold-based migration method incorporated into the method of FIG. 4 for migrating pages in the page region to the block region;

FIG. 8 illustrates a Block B+ tree structure used by the method of FIG. 7;

FIG. 9 is a table of configuration parameters of a simulated SSD used in simulations to benchmark the method of FIG. 4 against different buffer caching schemes;

FIG. 10 is a table of configuration parameters characterising different types of workload used in the simulations of FIG. 9 to benchmark the method of FIG. 4;

FIGS. 11 to 14 show multiple series of graphs depicting benchmark results obtained from performing the simulations of FIG. 9;

FIG. 15 shows a series of graphs relating to distributions of write length for a 16 MB data buffer size in studying the different buffer caching schemes under different workloads;

FIG. 16 shows a series of graphs relating to total read pages to study the overheads of the different buffer caching schemes under different workloads;

FIG. 17 shows a series of graphs illustrating effects of a threshold on the method of FIG. 4, specifically for determining the page migration of FIG. 7; and

FIG. 18 is a schematic diagram illustrating deployment of the method of FIG. 4 on a typical SSD for managing the write buffer and read cache thereof.

### DETAILED DESCRIPTION OF PREFERRED EMBODIMENTS

### Hybrid Management

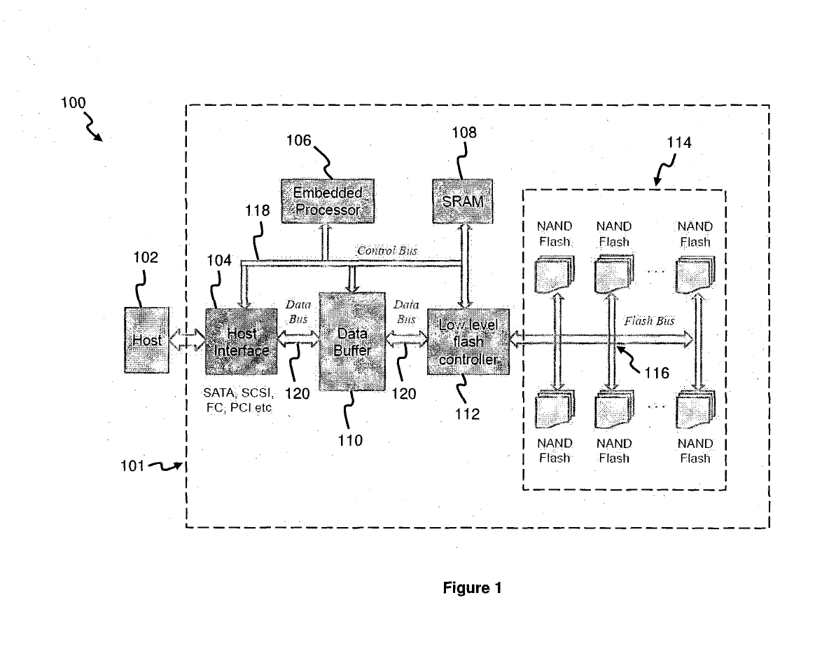

FIG. 1 shows a system architecture 100 of a solid-state device (SSD) (hereinafter SSD architecture) implemented within a SSD 101 according to a first embodiment. The SSD 101 is accessible by a host system 102 (e.g. a personal computer), which includes a host processor (not shown). In particular, the SSD architecture 100 includes a host interface unit 104, which enables the host system 102 to gain system access to the SSD 101. The host interface unit 104 is implementable using any existing host interfacing standards (e.g. Serial Advanced Technology Attachment (SATA), Small Computer System Interface (SCSI), Fibre Channel (FC), Peripheral Component Interconnect (PCI) or the like) known to a skilled person.

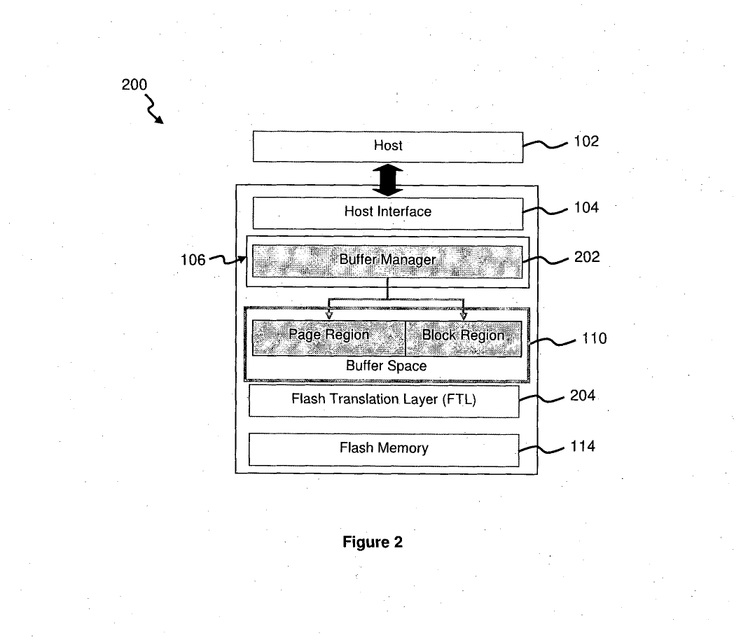

Additionally, the SSD architecture 100 also includes an embedded processor 106, a static ram (SRAM) module 108, a data buffer 110 (or also otherwise termed as buffer space or buffer memory), and a low-level flash memory controller 112, which is in turn electrically coupled to and for controlling a plurality of NAND flash memory modules (hereinafter NAND modules) 114. Together, the NAND modules 114 form the flash memory (and to be referred to as such hereinafter). It is also to be noted that the data buffer 110 is realisable using volatile memory DRAM or non-volatile memory (e.g. Spin-Torque Transfer Magnetic RAM (STT-MRAM), Phase Change RAM (PCRAM) or the like). FIG. 2 is now referred to, which shows an alternative representation of the SSD architecture 100 to more clearly illustrate the relationship between the embedded processor 106 and the data buffer 110. Specifically, FIG. 2 illustrates that the embedded processor 106 includes a buffer manager 202 for performing and executing hybrid buffer management algorithm/policy. In addition, a Flash Translation Layer (FTL) 204 interfaces the data buffer 110 with the flash memory 114.

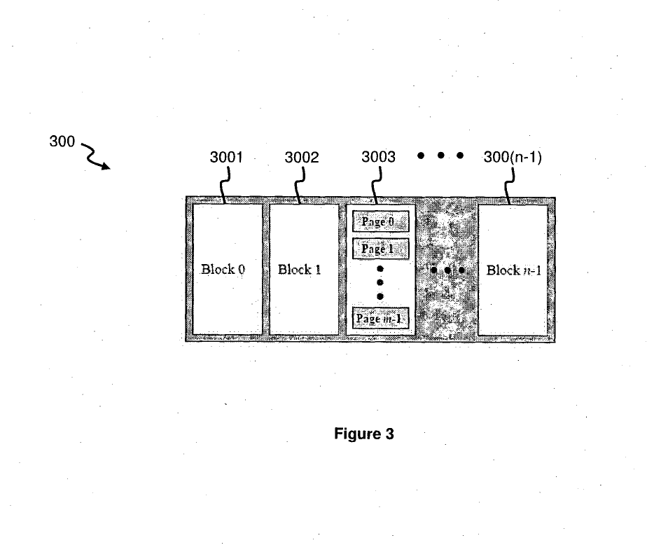

Accordingly, organisation of the flash memory 114 into respective memory blocks 3001, 3002, 3003 . . . 300(n−1) is shown in FIG. 3. Each memory block 3001, 3002, 3003 . . . 300(n−1) is organised into a plurality of between 64 to 128 memory pages. Each of the NAND modules 114 forming the flash memory is communicably interconnected to each other via a flash bus 116. Further, a control bus 118 also communicably interconnects the host interface unit 104, embedded processor 106, SRAM module 108, data buffer 110, and memory controller 112 to one another.

It should be appreciated that each memory block includes a same number of pages as an erasable block in the flash-based memory. For example, if there are 64 pages in the erasable block, then each memory block would also comprise 64 memory pages.

During operation, the embedded processor 106 processes any incoming/outgoing requests from/by the host system 102/memory controller 112, while the SRAM 108 functions to provide a working memory area for the embedded processor 106 for the processing of those requests. Based on a specific data access request received, the host interface unit 104 searches the requested data in data buffer 110. If the request is hit in the data buffer 110, the requested data will be transferred to host 102 via the host interface unit 104. If the request is not hit in the data buffer 110, the memory controller 112 then, with reference to a lookup table (not shown), retrieve the data from the associated flash memory 114. The retrieved data is subsequently forwarded by the memory controller 112 to the host interface unit 104 via the data buffer 110, and eventually transmitted out to the host system 102. The data buffer 110, host interface unit 104, and memory controller 112 are interfaced to each other via a data bus 120.

Further embodiments of the invention will be described hereinafter. For the sake of brevity, description of like elements, functionalities and operations that are common between the embodiments are not repeated; reference will instead be made to similar parts of the relevant embodiment(s).

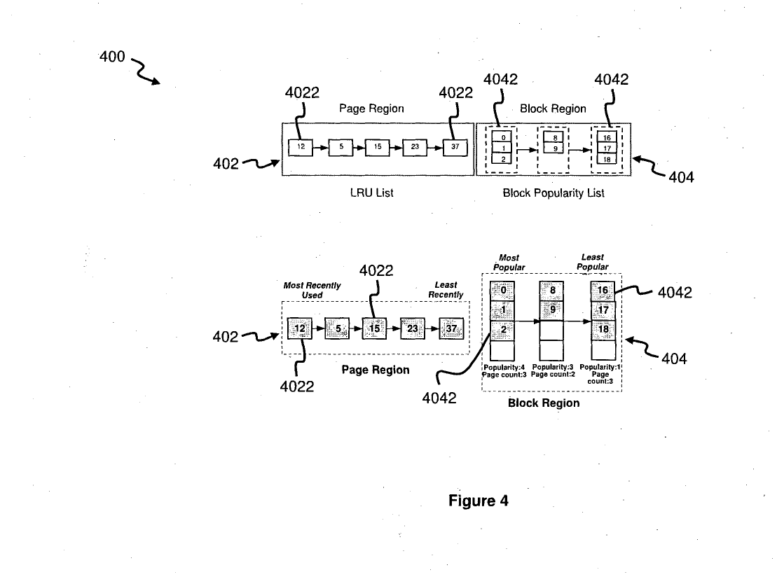

Random (data) accesses are small and popular in characteristics, and have high temporal locality. Page-based buffer management offers good performance in terms of exploiting temporal locality to achieve a high cache hit ratio. On the other hand, sequential (data) accesses are large and unpopular, and characterised by high spatial locality. Therefore, block-based buffer management schemes are able to offer good performance by effectively exploit spatial locality. FIG. 4 illustrates a Hybrid Buffer Management (HBM) method 400 (hereinafter HBM), according to a second embodiment, designed and configured to exploit the associated advantages with reference to the above knowledge. In particular, HBM 400 is installed on the SSD 101, and configured (at the software level) to be executed by the embedded processor 106 during operation. HBM 400 is implementable as a firmware/software or as a piece of independent FPGA/ASIC code, and thereafter storable in a flash memory. On the other hand, HBM 400 is also implementable in the embedded processor 106 as FPGA/ASIC code. Notably, in order to fully utilise both temporal and spatial localities found in enterprise-level workloads, HBM 400 logically partitions (i.e. divides on a software level) the data buffer 110 of the SSD 101 into a page region 402 and a block region 404. In the page region 402, buffered data is managed based on page granularity in order to improve buffer space utilisation (i.e. page-based buffer management), whereas in the block region 404, buffered data is managed based on logical block granularity to improve the sequentiality of flushed data (i.e. block-based buffer management).

A (data) page is located in either the page region 402 or the block region 404, as both regions 402, 404 are configured to service incoming data access requests (from the host system 102). Pages 4022 in the page region 402 are organised in accordance with the form of a page-based Least Recently Used (LRU) list (i.e. to be ordered from most-recently-used at the head of the list to least-recently-used at the end of the list). When a page 4022 cached in the page region 402 is accessed (i.e. a read/write), this page 4022 is then moved to the head of the page LRU list, as a result of the page recency.

On the other hand, (data) blocks 4042 in block region are indexed and organised on the basis of block popularity (i.e. from most popular to least popular), and the information related to such is stored in a block list. Importantly, block popularity is defined as block access frequency, including read and write of any pages of a block 4042. Each block 4042 is also associated with a corresponding popularity index, which tracks the access popularity of the block. When a page of a block 4042 is accessed, the popularity of the block 4042 is then accordingly increased by one count (i.e. increments the block's popularity index). It is to be emphasised that sequentially accessing multiple pages of a block 4042 is considered as one block access instead of multiple accesses, based on the current embodiment. Thus, a block 4042 with sequential accesses has low popularity value, while a block 4042 with random accesses has high popularity value. In addition, blocks 4042 with the same popularity are sorted based on the number of pages in the block 4042.

Temporal locality among the random accesses and spatial locality among sequential accesses are hence fully exploited by HBM 400 in using page-based buffer management and block-based buffer management respectively.

### Servicing Both Read and Write Operations

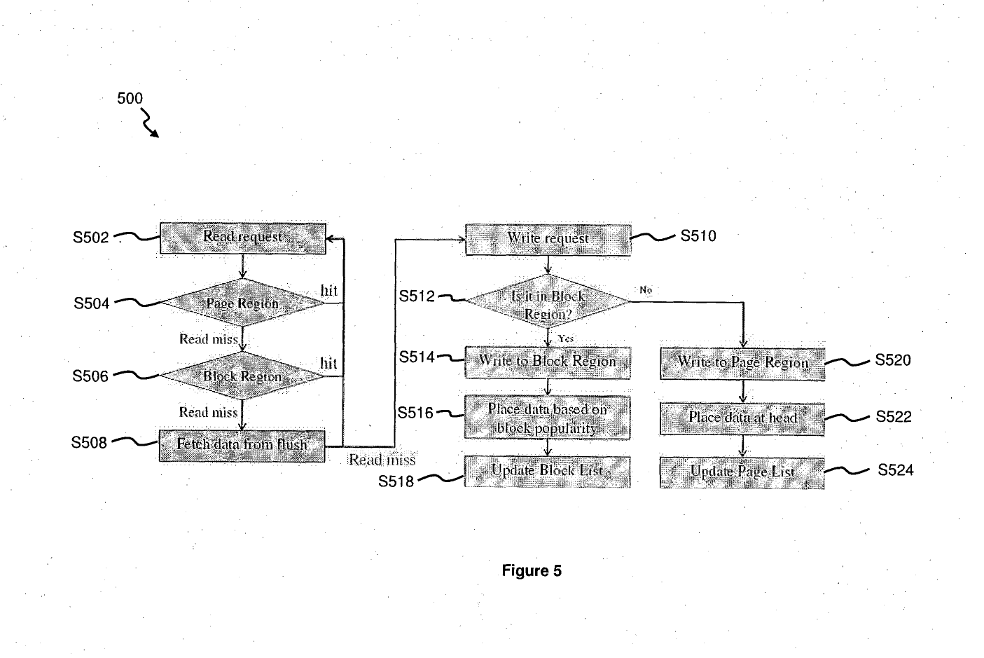

FIG. 5 is a flow diagram 500 illustrating how HBM 400 manages read/write access requests. In relation to servicing a read request at step S502, HBM 400 first attempts to fetch data from the page region 402 at step S504, and, if a read miss occurs, thereafter switches to fetch the data from the block region 404 at step S506. If the read request is not “hit” in the data buffer 110 (i.e. the request cannot be fulfilled due to the data not being currently found/stored in the data buffer 110), HBM 400 consequently fetches the required data from the flash memory 114 at step S508, and a copy of the retrieved data is subsequently stored in the data buffer 100 to facilitate quicker future accesses, without having to incur a read miss penalty. It is to be appreciated that retrieving data from the flash memory 114 is considerably slower than from the data buffer 110. Now referring to receipt of a write request at step S510, HBM 400 stores the data relayed together with the write request into the data buffer 110, rather than also synchronously writing the data into the flash memory 114.

More specifically, for both reading missed data and writing data, HBM 400 stores the data in the page region 402 or block region 404 in the following manner: at step S512, HBM 400 determines if the block of the data is already located in the block region 404. If the corresponding block of the writing data is ascertained to already exist in the block region 404, HBM 400 then writes the data into the block region 404 at step S514, and stores the data together in a corresponding block 404. Specifically, data is written to the block region if the block (but not data itself) the data belongs to is already found there. Any writing data is considered as belonging to one block. If the corresponding block of the writing data exists in the block region, the writing data is written to the block region. For example, a “Block 1” contains “page0” and “page 1” in the block region. Since newly writing data “page 2” belongs to the “Block 1”, “page 2” is written into the block region. Consequently, “Block 1” contains “page 0”, “page 1” and “page 2” in the block region. The popularity index of this corresponding block 404 is thereafter updated at step S516, and reorders the block list with the sequence of popularity updated at step S518. Otherwise HBM 400 writes the data to the head of the page region 402 at steps S520 and S522 respectively, because the page region 402 is managed based on using the page-based LRU, as afore described. To recap, the algorithm of the page-based LRU assigns the most recently accessed page to the front (i.e. head) of the LRU list. In other words, the foremost page in the LRU list is thus the most recently accessed page. HBM 400 thereafter updates a Block B+ tree (which forms the LRU list) at the final step S524, which is to be elaborated in later parts of the description

### Replacement Policy

Popular data are updated more frequently, as it is known. Therefore, when data replacement is carried out, unpopular data are instead to be replaced rather than popular data. It is to be appreciated that maintaining popular data in the data buffer 110 for as long as possible minimises the cost of incurring a write miss. For this reason, the configuration of HBM 400 is such that preference is given to random access pages to be maintained in the page region 402, whereas sequential access pages in the block region 404 are to be replaced first.

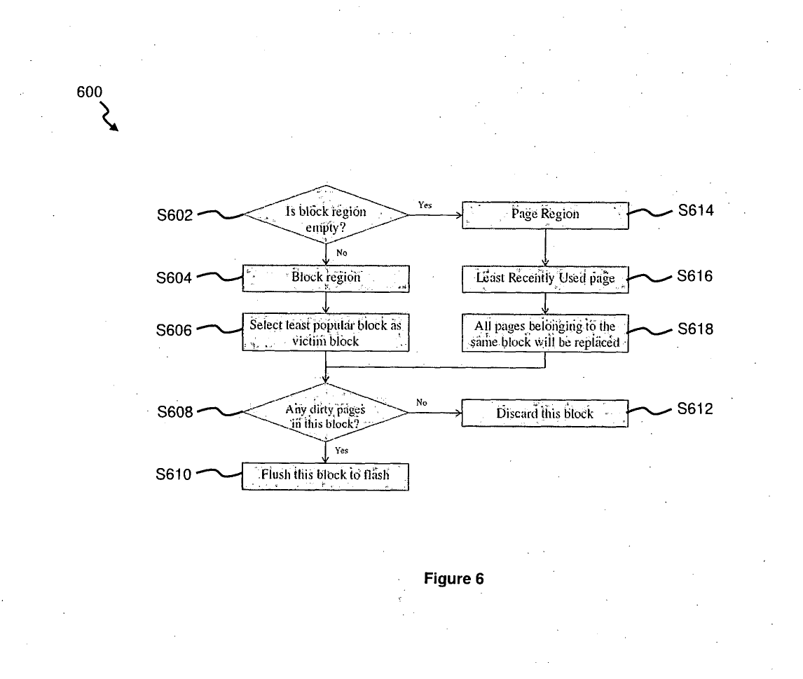

FIG. 6 shows a replacement policy method 600 incorporated into the HBM 400. At step S602, a determination is made to ascertain whether the block region 404 is empty. If the block region 404 is not empty, the flow of the replacement policy method 600 is then routed to processing the block region 404 at step S604. Specifically, the least popular block 4042 in the block region 404 is selected as a victim block 4042 at step S606. A victim block is defined to be a block 4042 that is to be discarded or flushed to the flash memory 114. It is to be appreciated that if more than one block 404 possesses the same degree of least popularity, a block 4042 with more pages is then selected as the victim block 4042. Once a block 4042 is selected as the victim block 4042, a determination is made at step S608 to ascertain whether there are any dirty pages in the selected block 4042. If dirty pages are located in this block 4042, both the dirty pages and clean pages within the block 4042 are sequentially flushed to the flash memory 114 at step S610. However, if no dirty pages are found in the selected block 4042, all the clean pages within the block 4042 are thereafter discarded at step S612.

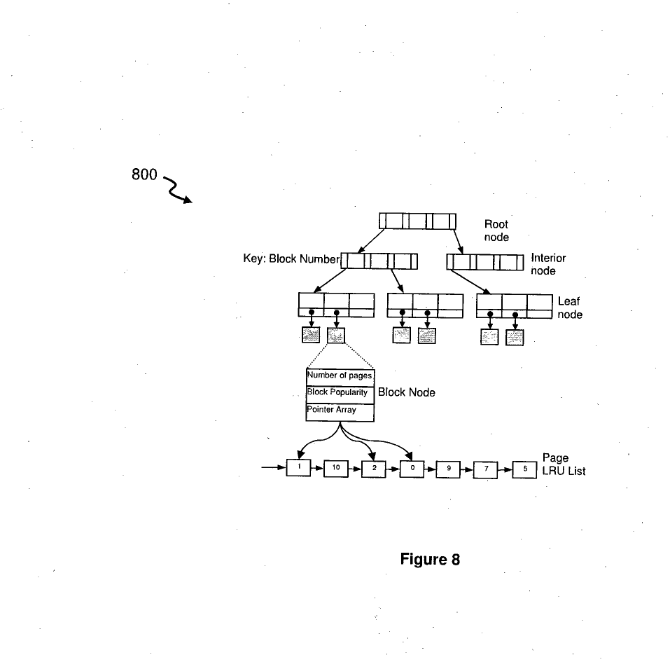

Referring back to step S602, if the block region 404 is determined to be empty, the flow of the replacement policy method 600 is accordingly routed to processing the page region 402 at step S614. Further, at step S616, the least recently used page is selected as a victim page 4022 from the page region 402. Following on, all corresponding pages belonging to the same block 4042 as this victim page 4022 are replaced and flushed from the data buffer 110 at step S618. Specifically, the victim page 4022 is linked to the blocks in the block region 404 to determine where the corresponding pages are located in the following manner. In the page region 402, certain pages belong to a block, and pages in the page region 402 are ordered as the LRU list. When replacement in the page region 402 occurs, the least recently used page in the tail of the LRU list is selected as the victim page 4022. However, to avoid a single page flush, other sibling pages in the page region 402 belonging to the same block as the victim page 4022 are to be flushed together. Further, the page region 402 also maintains block association of the pages by using a Block B+ tree 800 (to be explained with reference to FIG. 8 below). To elaborate, when a victim page 4022 is selected for replacement, and flushed from the page region 402, there are two types of cases to be processed. The first case is where there are no associated sibling pages of the victim page 4022. As a result, only the victim page 4022 is replaced. The second case is where there are sibling pages belonging to same block 4042 as the victim page 4022. Accordingly, the sibling pages together with the victim page 4022 are flushed. It is to be appreciated that the replacement policy method 600 is formulated to avoid executing a single page flush, which highly negatively impacts the garbage collection and internal fragmentation.

In summary, a block in the block region 404 with the smallest popularity is selected as the victim block 4042. If there are multiple blocks with the same least popularity value, a block having more pages is then selected as the victim block 4042 (noted that this is not shown in the FIG. 6). After the victim block 4042 is determined, the same block is still checked to determine whether it contains any dirty pages (at step S608). If the victim block 4042 contains dirty pages, the whole block data is then flushed to flash memory 114, or otherwise just discarded.

### Threshold-Based Migration

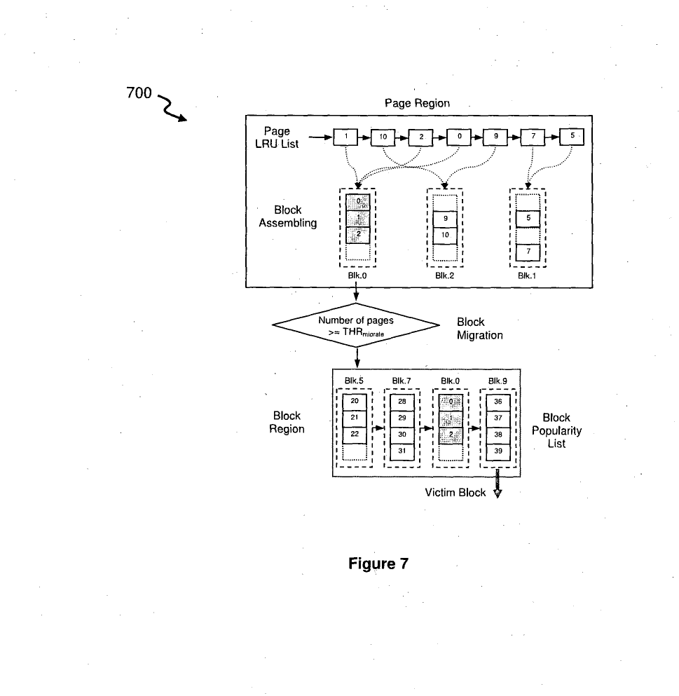

FIG. 7 illustrates a threshold-based migration method 700 incorporated into HBM 400 for migrating pages 4022 in the page region 402 to the block region 404. Particularly, buffer data stored in the page region 402 are migrated to the block region 404, if the number of pages in a block 4042 (as assembled) reaches a threshold value (i.e. upon satisfaction of the following condition: “Number of pages>THR_{migration}”). The determination of the threshold value is described later below in the “Dynamic Threshold” section. In other words, if the number of pages in an assembled block 4042 reaches/exceeds the threshold value, “THR_{migration}”, then all of the pages in the assembled block 4042 are migrated to the block region 404. It is to be appreciated that the page region 402 sorts the data based on page granularity and block region sorts the data in terms of block granularity. Replacement in the page region 402 is performed on the base of the page LRU list. However, the page region 402 also maintains block association of buffered pages in the page region 402 for block assembly and data migration. By maintaining the block association of the buffered pages, it becomes possible to determine which pages are to be migrated. Block assembly is configured to be dynamic and to always maintain the block association. With the filtering effect of the threshold, random pages thus remain stored in the page region 402, while sequential blocks accordingly reside in the block region 404. As a result, temporal locality among the random pages and spatial locality among the sequential blocks are utilised to full advantage by HBM 400 as configured.

Further, it is to be emphasised that in FIG. 7, the assumption of a block 4042 consisting of four pages is made for ease of explanation, and is not to be construed as limitative. The pages 4022 in the page region 402 are assembled based on block association (i.e. block assembling), and the respective page number is used to calculate the corresponding block number. Specifically, the quotient result obtained, by executing a calculation methodology being “page number divided by block size”, is used to determine a block 4042, to which the particular page 4022 is to be assigned. In particular, the quotient value indicates the block number of the block 4042 being assigned. For example, “page 1” is allocated to “block 0” because the quotient value is zero when one (i.e. the page number) is divided by four (i.e. the block size), or “page 9” is allocated to “block 2” because the quotient value is two when nine (i.e. the page number) is divided by four (i.e. the block size). In this instance as shown in FIG. 7, the grey-coloured boxes denote that a block 4042 has been assembled from the corresponding pages 4022 and migrated to the block region 404.

FIG. 8 shows a Block B+ tree structure 800 used by HBM 400 for maintaining the block association of the pages 4022 in the LRU list, and illustrates a detailed implementation of the block assembly. It is also to be appreciated that both the LRU list and the Block B+ tree 800 require maintenance using system resources (e.g. memory space), which is nonetheless considered to be very minimal, relative to existing schemes. It is to be noted that the Block B+ tree 800 uses a block number as a key. With further reference to FIG. 8, a data structure termed as a block node is hereby introduced to describe a block 4042 in terms of the block popularity, a number of pages in a block 4042 (which includes both clean and dirty pages), and a pointer array. Specifically, pointers in the array point to pages belonging to a same block 4042. It is to be appreciated that the page region 402 is managed based on page granularity and the block region 404 is managed based on block granularity. The pages 4022 in the page region 402 are selected to be migrated to the block region 404 if the number of pages in a block reaches the threshold value. Since entries in the block list are indexed according to block popularity, the information pertaining to block popularity is then maintained in the page region 402 to facilitate future migration. Particularly, the information pertaining to block popularity is maintained in page region using the Block B+ tree as shown in FIG. 8. It is specifically helpful to place the migrated block at right location in block region based on block popularity. Subsequently, a migrated block is stored at a corresponding location in the block region 404, and an entry corresponding to the migrated block is then inserted into the block list according to its popularity.

### Dynamic Threshold

HBM 400 is configured to improve the sequentiality of accesses to the flash memory 114, while simultaneously maintaining high utilisation of the data buffer 110. The threshold value (i.e. “THR_{migrate}”), which is critical to the efficiency of HBM 400, is then determined accordingly in order to attain a reasonable balance in achieving the two aforementioned objectives. More particularly, the threshold value is highly dependent on workload features, and as a result, it becomes fairly challenging to determine a static and well-performed threshold value for a wide range of envisaged workloads. For random dominant workload, a small threshold value is found to be appropriate because it is difficult to form sequential blocks. However, for sequential dominant workload, a large threshold value is desirable because a lot of partial blocks, instead of full blocks, may be migrated away from the page region 402 to the block region 404, if a small threshold value is adopted.

Specifically, the threshold value of “THR_{migrate}” varies from a value of “1” to the total number of pages within a block 404. Two variables “N_{block}” and “Nₜₒₜₐₗ” are now introduced, in which they respectively represent the size of the block region 404 and the total size of the data buffer 110. A parameter, “γ”, is used to denote the ratio between the two variables “N_{block}” and “Nₜₒₜₐₗ”, and the value of “γ” is to be calculated with reference to the following limit defined in equation (1), which is used to dynamically ascertain whether to increase or reduce the threshold value.

$$γ = \frac{{N}_{block}}{{N}_{total}} \leq θ \qquad ( 1 )$$

where “θ” represents a parameter to be configured based on the size of the data buffer 100. As the size of the block region 404 is configured to be much smaller than the size of the page region 402, the value of “θ” is accordingly defined to be at 10% and 20% respectively for small-sized and large-sized data buffer 110. Also, the threshold value is initially defined to have a value of “2”. It is to be appreciated that the threshold value is initially defined to be “2” because while the threshold value is definable to be any integer from “1” to “64” in, for example, a flash block that consists of 64 pages, setting the threshold value to be “1” is considered meaningless, as the whole buffer is consequently configured to be page based. Accordingly, the next logical value to adopt for the threshold value is therefore “2”. In addition, setting the threshold value as “2” at the initial stage is based on an empirical approach because the threshold value is subsequently to be adaptively adjusted based on the equation (1). However, if the value of “γ” subsequently becomes larger than “θ”, it then indicates that the size of the block region 404 does not satisfy the limit of equation (1). Thereafter, the threshold value is then to be doubled until the value of “γ” is less than that of “θ”, in order to reduce the size of the block region 404. It is to be appreciated that having a large threshold value increases the difficulty of facilitating page migration from the page region 402 to the block region 404. On the other hand however, if the block region 404 is determined to be empty, the threshold value then needs to be halved.

Accordingly, HBM 400 is evaluated via simulations using the following experimental setup, the details of which are provided below.

### (a). Experimental Setup

### (i). Trace-Driven Simulator

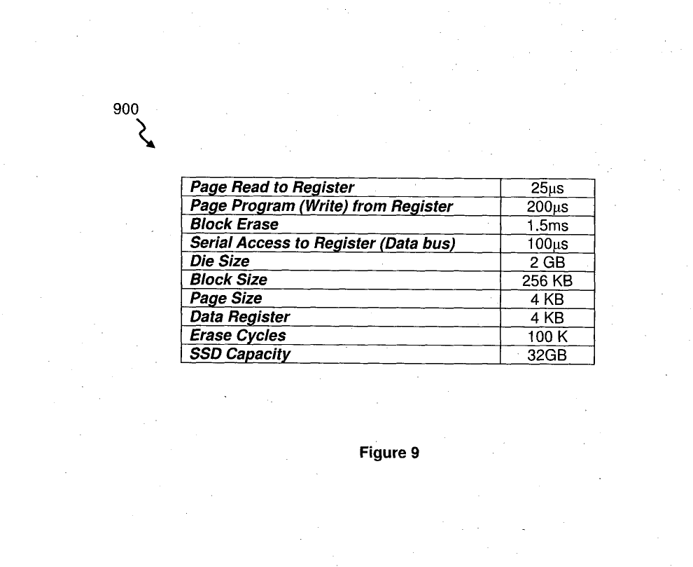

A trace-driven simulator loaded with algorithms of different buffer caching (or buffer management) schemes including HBM 400 (of the present embodiment), BPLRU, FAB, and LB-CLOCK for benchmarking them against one another is adopted. Accordingly, FIG. 9 shows a table 900 presenting the respective configuration parameters of a simulated SSD used in simulations to benchmark HBM 400 against the rest of the other buffer caching schemes.

### (ii). Workload Traces

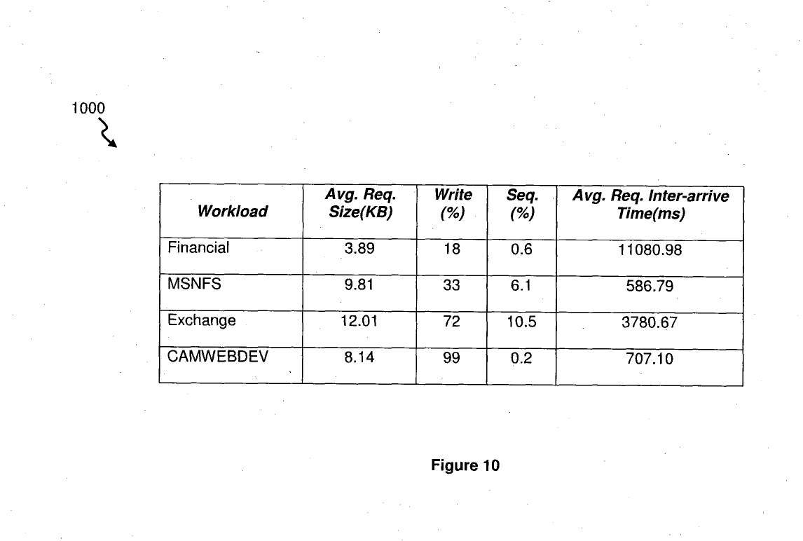

In addition, a set of real-world traces, representing different types of workload, is used to extensively evaluate HBM 400 in order to study the efficiency of the different buffer caching schemes versus HBM 400 on a wide spectrum of enterprise-level workloads. Accordingly, FIG. 10 shows a table 1000 of the respective configuration parameters characterising the salient features of different types of workload used in the simulations. Specifically, the set of four workload traces (i.e. “Financial”, “MSNFS”, “Exchange”, and “CAMWEBDEV”) used in the simulations cover wide range of workload characteristics from random to sequential, and from read dominant to write dominant.

(iii). Evaluation Metrics

The following parameters are used as metrics for evaluation of the simulation results: (i). response time, (ii). number of erases (i.e. indicators of the garbage collection overhead), (iii). cache hit ratio, and (iv). distribution of write length (i.e. indicators of sequentiality of write accesses forwarded to the flash memory 114). Collectively, these parameters provide information to characterise the behaviour and performance of the different buffer caching schemes being studied via the simulations.

### (b). Evaluation Results

### (i). Performance

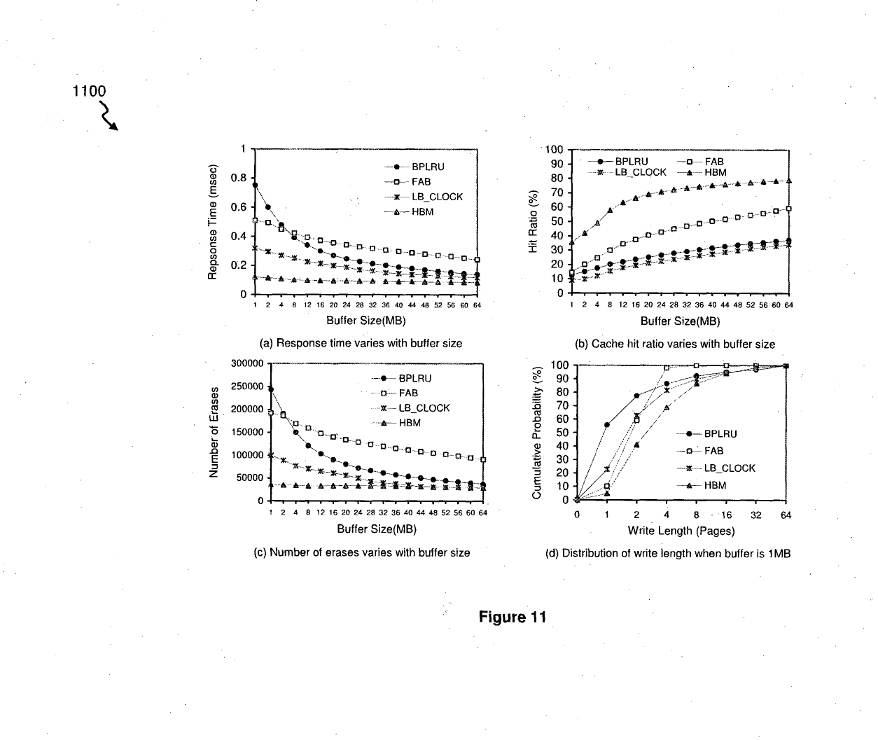

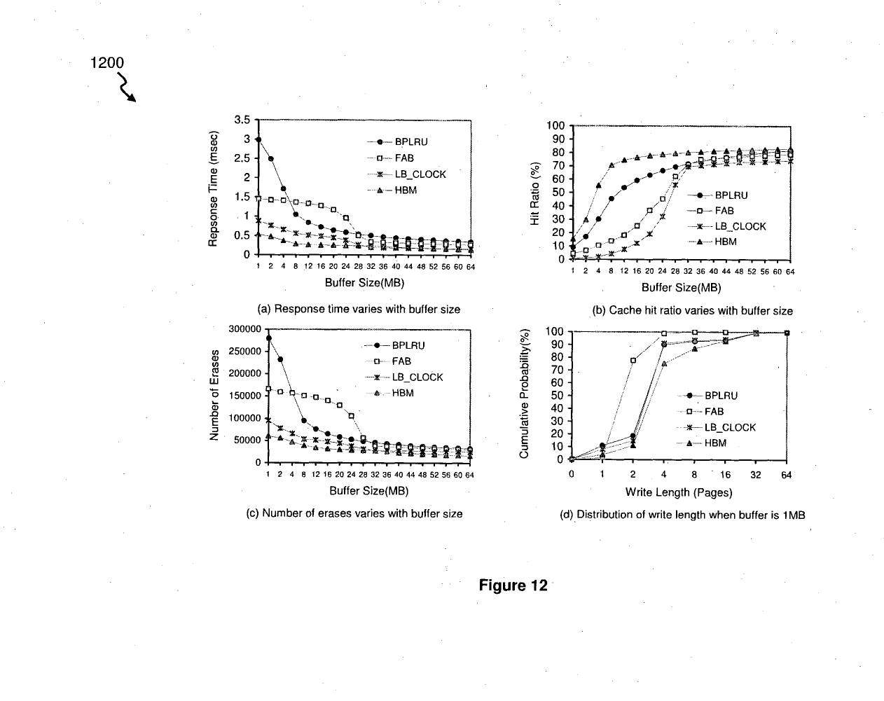

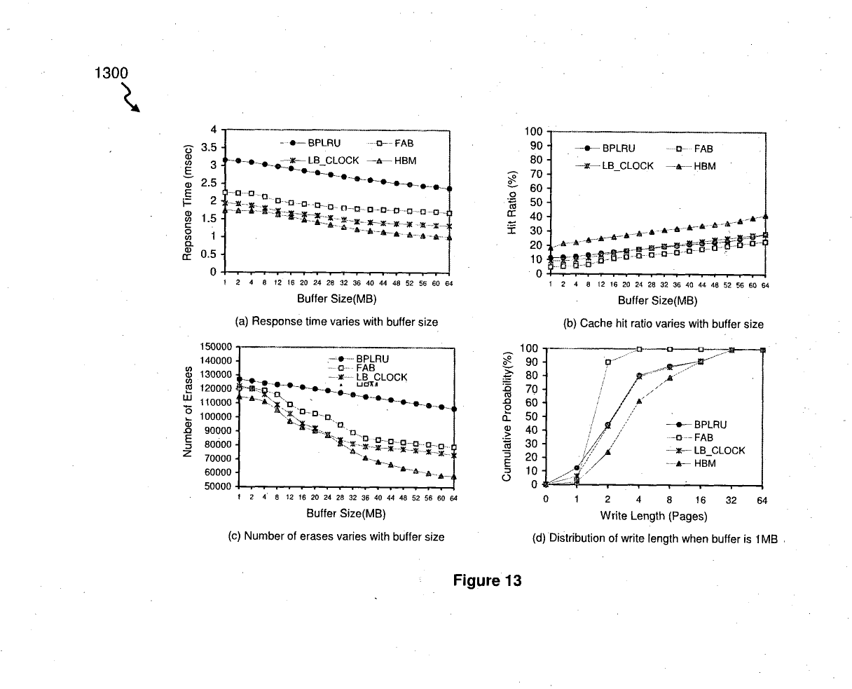

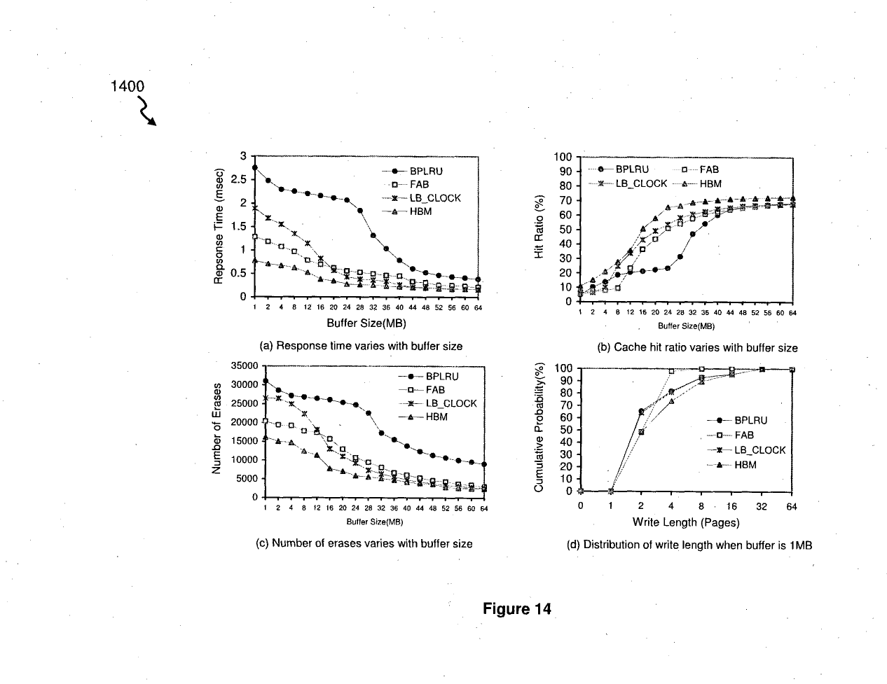

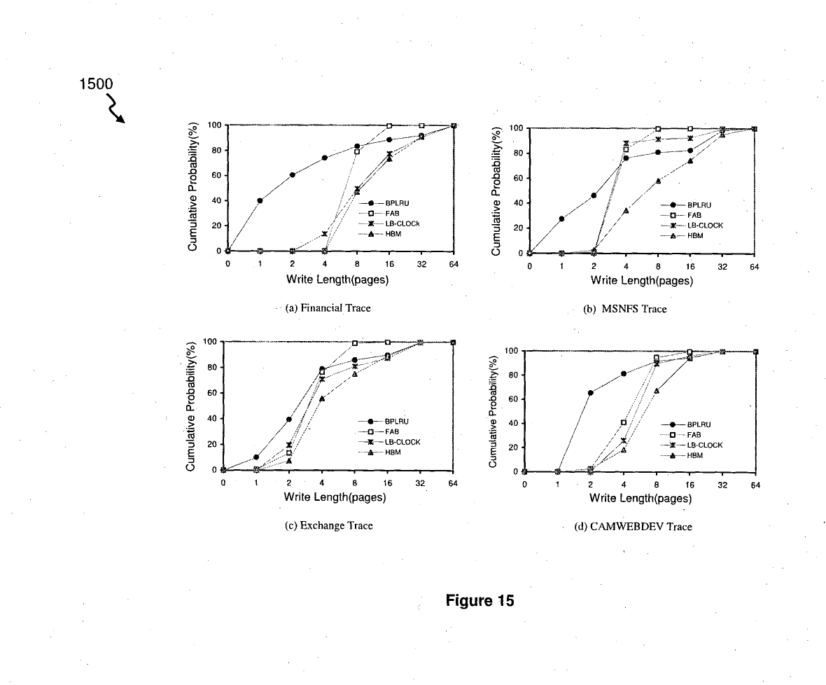

Following on, FIGS. 11 to 14 are graphs 1100, 1200, 1300, 1400 depicting the evaluation (benchmark) results obtained from the simulations performed using the trace-driven simulator as described in section (a)(i). In particular, the graphs 1100, 1200, 1300, 1400 provide graphical information relating to (i). average response time, (ii). cache hit ratio, (iii). number of erases, and (iv). distribution of write length of the different buffer caching schemes with respect to the four types of workload being employed, and when the size of the data buffer 110 is varied. It is to be further highlighted that in order to indicate the write length distribution, the graphs 1100(d), 1200(d), 1300(d), 1400(d) are plotted as Cumulative Distribution Function (CDF) curves to present the proportion of written pages (in percentages on the Y-axis) having sizes below than a certain value (as shown on the X-axis). Additionally, due to space constraints, only the CDF curves for a 1 MB data buffer configuration are shown in FIGS. 11 to 14. The CDF curves for a 16 MB data buffer configuration, in respect of different workload traces, are instead presented in FIG. 15. It is to be appreciated that the benchmark results, as depicted in the graphs 1100, 1200, 1300, 1400, demonstrate that HBM 400 is able to achieve a performance improvement of up to 84% (in terms of average response time), a cache hit ratio improvement of up to 185%, a number of erase reduction of up to 85%, and a write sequentiality improvement of up to 30%.

In summary, the benchmark results indicate that the performance gain of HBM 400 is derived from two aspects: having a high cache hit ratio, and reduced garbage collection. Specifically, HBM 400 exploits the inherent characteristics of the pages 4022 and blocks 4042 to manage the data buffer 110 in a hybrid manner, which importantly takes into consideration both the temporal and spatial localities. HBM 400 is thus advantageous compared to the existing schemes due to the improved cache hit ratio and the increased portion of sequential writes being executed.

### (ii). Additional Overhead

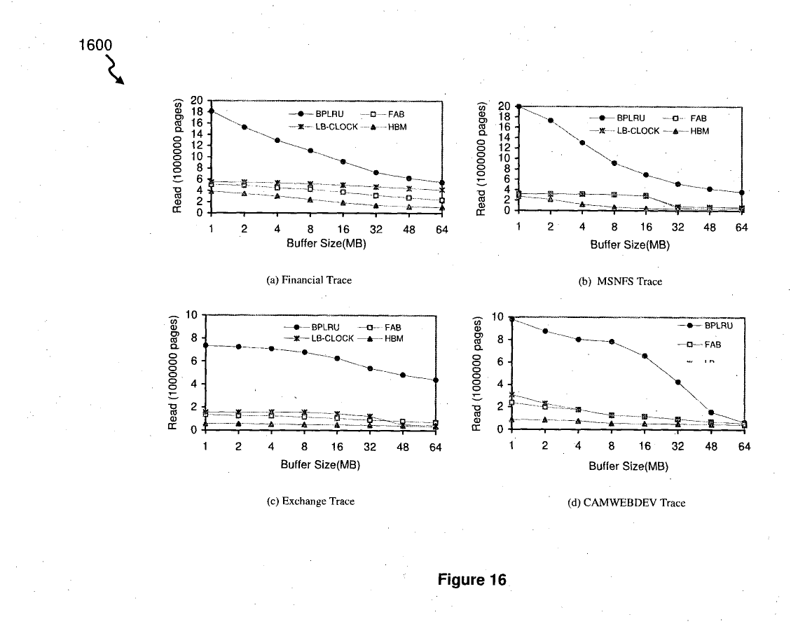

In order to investigate the overhead incurred by the various buffer caching schemes under different workloads, the total number of read pages during replaying the workload traces is shown in the graphs 1600 of FIG. 16. From the results, it is determined that BPLRU performs a large number of read operations. For example now with reference to FIG. 16(a), it is observed that for a data buffer size of 1 MB, BPLRU incurs 368%, 257%, and 238% more page reading than HBM, FAB and LB-CLOCK respectively. Accordingly, the average response time of BPLRU is then 523%, 48% and 138% slower than HBM, FAB and LB-CLOCK respectively (i.e. refer to FIG. 11(a)). The reason for this is because BPLRU is configured to use page padding to improve the number of sequential writes. However, for completely random workload in enterprise-level environments, BPLRU then requires reading in of a large number of additional pages, which consequently impacts the overall performance negatively.

In contrast, HBM 400, according to the current embodiment, achieves better relative performance without necessitating additional reads. Specifically, HBM 400 buffers both read and write accesses, and leverages the block-level temporal locality among read and write accesses for forming sequential blocks.

### Effect of the Threshold Value: “THR_{migrate}”

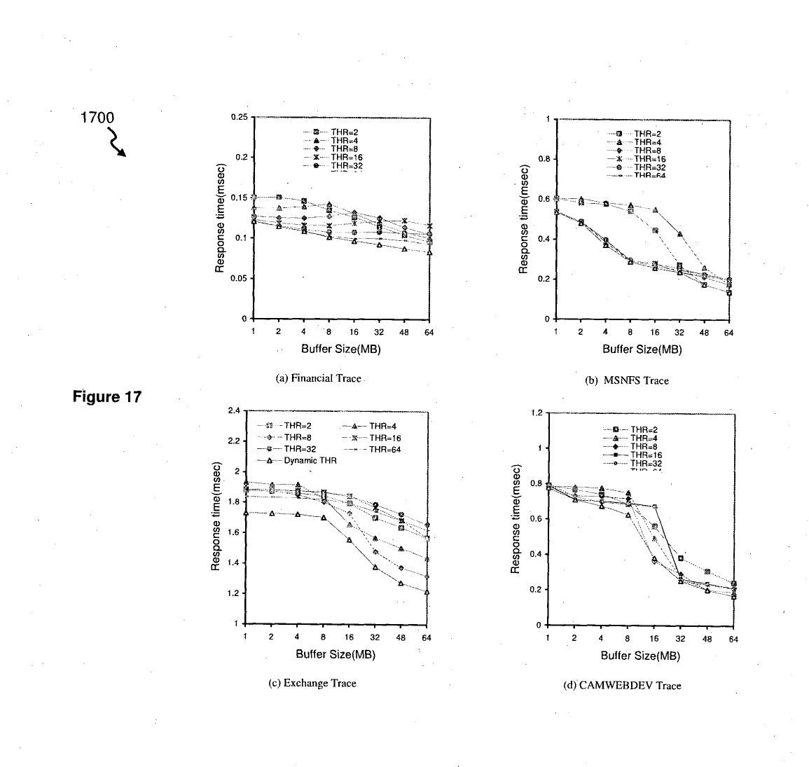

For investigating how the threshold value, “THR_{migrate}”, affects the efficiency of HBM 400, the performance of HBM 400 was studied using statically-defined thresholds and dynamically-defined thresholds with respect to different traces, as shown in the graphs 1700 of FIG. 17. The variation of the graphs 1700 clearly indicates that the threshold value has a significant impact on the efficiency of HBM 400. In detail, the graphs 1700 show that HBM 400 is unable to achieve optimal performance if the threshold value is statically-defined, whereas HBM 400 is able to achieve a desired performance if the threshold value is instead dynamically-defined. As a result, dynamically adjusting the threshold value for different workloads enables HBM 400 to be workload adaptive.

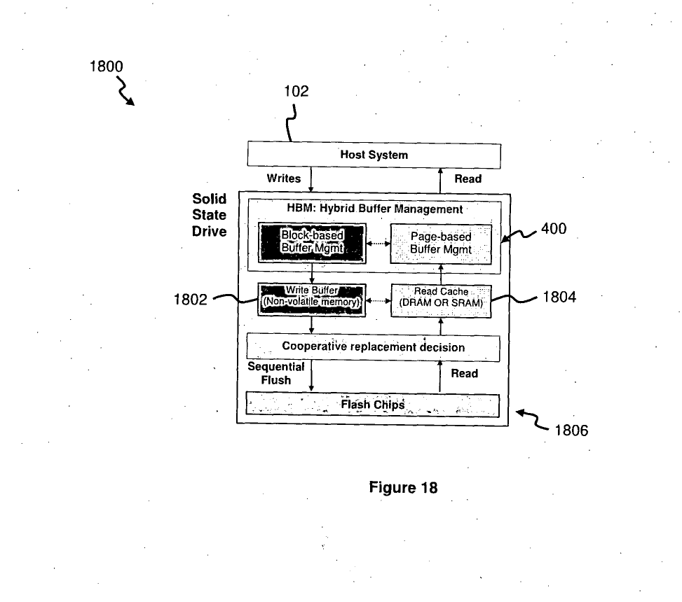

FIG. 18 is a schematic diagram 1800 illustrating the deployment of HBM 400 for managing the write buffer 1802 and read cache 1804 of a typical SSD 1806, as known to skilled persons. The write buffer 1802 is formed of non-volatile memory (NVM), and configured for buffer management based on block granularity. In contrast, the read cache 1804 is formed of DRAM or SRAM, and configured for buffer management based on page granularity. Particularly, block association is maintained between the write buffer 1802 and read cache 1804. Data in the write buffer 1802 are to be replaced and flushed into the flash memory storage by cooperatively considering the data in the read cache 1804 according to this policy: replacing and flushing both data in the write buffer 1802 and read cache 1804 belonging to the same block.

In summary, the SSD 1806 is equipped with non-volatile memory to be configured as the write buffer 1802 and a small volatile memory (i.e. DRAM/SRAM) as the read cache 1804. The write buffer 1802 is for storing writing data, while the read cache 1804 is for storing reading data. The write buffer 1802 and read cache 1804 works independently without need for any intercommunication. The write buffer 1802 is managed based on block granularity and the read cache 1804 is managed based on page granularity. Block association is then maintained between the write buffer 1802 and read cache 1804 to indicate which data in the read cache 1804 and write buffer 1802 belong to the same block. It will be appreciated that the information relating to the block association is then storable in the working memory of the SSD 1806.

Moreover, data in the read cache 1804 is sorted as the page-based LRU list. If the read cache 1804 is determined to be full, the least recently used page in the LRU list is then discarded. On the other hand, the write buffer 1802 is configured to be sorted in the form of a block popularity list. Specifically, if the write buffer 1802 is full, the least popular block is then selected as the victim block 4042. At the same time, pages in the read cache 1804 belonging to the same block are flushed together to increase the sequentiality of flushed data.

Advantages to HBM 400, based on the second embodiment, include leveraging the block-level temporal locality among read and write accesses to form sequential blocks (in relation to both read and write operations). Particularly, HBM 400 buffers both read and write accesses in order to advantageously use the locality of the accesses. HBM 400 also groups both dirty and clean pages belonging to the same erase block into a logical block in the block region 404. It is to be appreciated that existing schemes, such as BPLRU or LB-CLOCK, however focus only on the write buffer. BPLRU also uses page padding to improve the sequentiality of flushed data at a cost of additional reads, which negatively impacts the overall performance. Furthermore, for random dominant workload, BPLRU needs to read in a large number of additional pages. However, it is known that in real world environments, both read and write accesses may be combinatorially received. Therefore, servicing the read and write accesses separately in different buffer space may destroy the original locality among the access sequences. Moreover, servicing read accesses may help to reduce the load in the flash data channel, which is co-shared between the read and write accesses. In addition, servicing any foreground read operations may also help to conserve the bandwidth of the flash data channel for performing background garbage collection. It is to be appreciated that background garbage collection affects foreground user accesses because it consumes a large amount of bandwidth resources. Therefore, if read accesses is servable together with the write buffer, more bandwidth resources may be devoted for performing fast background garbage collection. In comparison, HBM 400 is designed and configured to overcome the aforementioned deficiencies of existing schemes.

In summary, the proposed HBM 400, adopts a dual objective of achieving high cache hit ratio, and good sequentiality by exploiting both temporal and spatial localities among access requests. HBM 400 logically partitions the data buffer 110 into the page region 402 and block region 404 for managing them 402, 404 in a hybrid manner, as proposed according to the second embodiment. In the page region 402, buffer data is managed based on page granularity for improving buffer space utilisation, while in the block region 404, data are managed based on block granularity. Accordingly, to achieve both the listed objectives, random access pages are then preferentially maintained in the page region 402, while sequential access pages in the block region 404 are to be first replaced.

Buffer data in the page region 402 is dynamically moved (i.e. migrated) to the block region 404, if the number of pages in a block reaches or exceeds a threshold value, which is adaptively determined based on different types of workload. By leveraging on the concept of hybrid management and dynamic migration, HBM 400 thus efficiently improves the corresponding related performance, and influences the Input/Output requests so that more sequential accesses are consequently forwarded to the flash memory 114. Specifically, comparing to existing SSD buffer management schemes, HBM 400 is advantageous in that it possesses higher performance (in terms of having higher cache hit ratio, and better sequentiality), incurs less garbage collection overhead, enables more sequential writes to be forwarded to the flash memory 114, is workload adaptive, and more cost effective due to higher utilisation of the data buffer 110.

The described embodiments should not however be construed to be limitative. For instance, it should be appreciated that each memory block 3001, 3002, 3003 . . . 300(n−1) in the NAND modules 114 may comprise other suitable numbers of memory pages, and is not limited to only 64 to 128 memory pages for each memory block 3001, 3002, 3003 . . . 300(n−1). In addition, for FIG. 18, the write buffer 1802 is not limited to being implementable using only non-volatile memory. Particularly, the write buffer 1802 and read cache 1804 may either be implementable using non-volatile or volatile memory. It is however to be appreciated that in practical applications, the write buffer 1802 is typically formed using non-volatile memory because any data stored are not lost if power is lost (e.g. due to device shutdown). The read cache 1804 is however not concerned about data lost if power is lost.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

1. A buffer management apparatus for managing transfer of data between a host processor and a flash-based memory, the apparatus comprising:
a buffer having a memory for caching the data to be transferred, the memory being logically partitioned as a page-based buffer partition configured with a plurality of first memory pages; and a block-based buffer partition configured with a plurality of memory blocks,
wherein each memory block includes a same number of pages as an erasable block in the flash-based memory; and the host processor being configured to access the page-based buffer partition or the block-based buffer partition based on type of data to be transferred.

2. The buffer management apparatus of claim 1, further comprising a processor configured to replace data in the page-based buffer partition based on Least Recently Used (LRU) algorithm.

3. The buffer management apparatus of claim 2, wherein each memory block of the block-based buffer partition is associated with a popularity index which tracks the number of times the associated memory block is accessed.

4. The buffer management apparatus of claim 3, wherein the data to be transferred includes sequential access of multiple pages of one of the memory blocks, and wherein the processor is configured to increase the popularity index associated with the one of the memory blocks by one count.

5. The buffer management apparatus of claim 3, wherein the data to be transferred includes random access of one of the pages of the memory block, and wherein the processor is configured to increase the popularity index associated with the memory block by one count.

6. The buffer management apparatus of claim 3, wherein if the access is a write operation, the processor is configured to check the block-based buffer partition for availability of a corresponding block of memory, and if available, to write to the corresponding block memory.

7. The buffer management apparatus of claim 6, wherein after the write operation, the processor is configured to update the popularity index and to reorder the memory blocks in the block-based buffer partition.

8. The buffer management apparatus of claim 6, wherein if the corresponding block of memory is not available, the processor is configured to write to beginning of the page-based buffer partition and update a block node with pages of the written data.

9. The buffer management apparatus of claim 2, wherein if the number of page in a block reaches a threshold, the processor is configured to migrate all pages of the block to the block-based buffer partition.

10. The buffer management apparatus according to claim 9, wherein the threshold is a value between 1 and the total number of pages in one erasable block of the flash-based memory.

11. The buffer management apparatus according to claim 9, wherein the processor is configured to determine a ratio of size of the block-based buffer partition and size of the buffer, and to dynamically modify the threshold based on the ratio.

12. The buffer management apparatus according to claim 3, wherein the processor is configured to replace data in the memory blocks of the block-based buffer partition based on the popularity index.

13. The buffer management apparatus according to claim 12, wherein the memory block having a lowest popularity index is replaced first.

14. The buffer management apparatus according to claim 12, wherein if a plurality of the memory blocks have a same popularity index, the memory block having more pages is replaced first.

15. The buffer management apparatus according to claim 13, wherein if there are dirty pages in said block, both dirty pages and clean pages of said block are sequentially flushed into the flash-based memory.

16. The buffer management apparatus according to claim 13, wherein if there are no dirty pages in said block, all the clean pages of said block is discarded.

17. The buffer management apparatus according to claim 13, wherein if a said block region is empty, the least recently used page is selected as a victim page from the page-based buffer partition; and wherein pages belonging to the same block as the victim page are replaced and flushed.

18. The buffer management apparatus of claim 1, wherein the flash-based memory is NAND memory.

19. A buffer management method for managing transfer of data between a host processor and a flash-based memory, the method comprising
logically partitioning a memory of a buffer for caching the data to be transferred as a page-based buffer partition and a block-based buffer partition;
configuring the page-based buffer partition with a plurality of first memory pages;
configuring the block-based buffer partition with a plurality of memory blocks with each memory block including a same number of pages as an erasable block in the flash-based memory; and
accessing the page-based buffer partition or the block-based buffer partition based on type of data to be transferred.

20. The buffer management method according to claim 19, further comprising dynamically migrating the data in the page-based buffer partition to the block-based buffer partition in dependence on a predetermined threshold value, which is adaptively adjusted in accordance to a workload representative of the transfer of the data between the host processor and flash-based memory.

21. A buffer for flash-based memory, the buffer comprising memory for caching data, the memory being logically partitioned as:
a page-based buffer partition configured with a plurality of first memory pages; and
a block-based buffer partition configured with a plurality of memory blocks, each memory block having a same number of pages as an erasable block in the flash-based memory, wherein whether the page-based buffer partition or the block-based buffer partition is accessed is based on type of data to be transferred.

22. The buffer for flash-based memory of claim 21, wherein the flash-based memory is NAND memory.

23. A buffer management apparatus configured for managing transfer of data between a host processor and a flash-based memory using a buffer management method for managing transfer of data between a host processor and a flash-based memory, the method comprising
logically partitioning a memory of a buffer for caching the data to be transferred as a page-based buffer partition and a block-based buffer partition;
configuring the page-based buffer partition with a plurality of first memory pages;
configuring the block-based buffer partition with a plurality of memory blocks with each memory block including a same number of pages as an erasable block in the flash-based memory; and
accessing the page-based buffer partition or the block-based buffer partition based on type of data to be transferred, the apparatus comprising:
a write buffer configured for buffer management based on block granularity; and
a read cache configured for buffer management based on page granularity,
wherein the data subsequently stored in the write buffer and read cache are associated based on block association, and the data stored in the write buffer are to be subsequently replaced and flushed to the flash-based memory in cooperative dependence on the data stored in the read cache.

24. The buffer management apparatus according to claim 23, wherein the data stored in the write buffer and read cache are subsequently replaced and flushed to the flash-based memory together, if the data stored in the write buffer and read cache belong to a same memory block.

25. The buffer management apparatus according to claim 23, wherein the write buffer and read cache include non-volatile memory or volatile memory.
